(19) United States
(12) Patent Application Publication
(10) Pub. No.: US 2025/0062514 A1
(43) Pub. Date: Feb. 20, 2025

(54) Electrode Protection Member and All-Solid-State Battery Including the Same

(71) Applicants: Hyundai Motor Company, Seoul (KR); Kia Corporation, Seoul (KR)

(72) Inventors: Yong Hun Lee, Hwaseong (KR); Ju Min Kim, Hwaseong (KR); Yong Jun Lee, Incheon (KR); Tae Young Kwon, Daegu (KR); Jong Hwan Choi, Hwaseong (KR)

(21) Appl. No.: 18/611,792

(22) Filed: Mar. 21, 2024

(30) Foreign Application Priority Data
Aug. 18, 2023 (KR) 10-2023-0108575

(51) Int. Cl. H01M 50/586; H01M 50/403; H01M 50/42

(52) U.S. Cl. CPC H01M 50/586; H01M 50/403; H01M 50/42

(57) ABSTRACT

Provided is an electrode protection member comprising a lower structure including a carbon-based tubular body whose surface is functionalized with a hydroxy group; and a composite resin part including a thermoset resin and an ultraviolet curing resin disposed on the lower structure, a manufacturing method of the electrode protection membrane, and an all-solid-state battery including the electrode protection member.

### CROSS-REFERENCE TO RELATED APPLICATION

This application claims under 35 U.S.C. § 119(a) the benefit of Korean Patent Application No. 10-2023-0108575 filed in the Korean Intellectual Property Office on Aug. 18, 2023, the entire contents of which are incorporated herein by reference.

### BACKGROUND

### Technical Field

The present invention relates to an electrode protection member for protecting an all-solid-state battery from an internal short circuit and an all-solid-state battery including the same.

### Background

Due to the depletion of fossil fuels and increasing demand for sustainable energy, research on low-cost, eco-friendly, high-performance energy conversion and storage devices, especially lithium secondary batteries, has been rapidly progressing. The scope of application of lithium secondary batteries is expanding not only for small electronic devices, but also as medium-to-large power devices for electric vehicles and energy storage systems (ESS).

In particular, as lithium secondary batteries are used as an energy source for electric vehicles, demand for lithium secondary batteries with high output and high energy density is rapidly increasing. However, existing lithium secondary batteries that use flammable liquid electrolytes have limitations, for example, safety problems such as leakage, ignition, and explosion due to rapid internal and external environmental changes such as temperature changes and external shocks. Accordingly, there is a need to use a solid electrolyte with more stable and long-life characteristics to replace the existing flammable liquid electrolyte.

However, in lithium all-solid-state batteries using a solid electrolyte, the area of the negative electrode coated with the solid electrolyte is larger than that of the positive electrode, so there is a high possibility that an internal short circuit is going to occur under high temperature and high pressure conditions. To solve this problem, a technology using glass or ceramics based on composite oxides mixed with SiO₂, MgO, ZnO, Na₂O, Al₂O₃, etc., which are internal short-circuit protection materials for all-solid-state batteries, has been proposed. However, there was a problem of cracks occurring under pressurized conditions because the step formed due to the difference in area between the negative and positive electrodes was not completely protected.

In addition, methods of using cured resins such as thermoset resins or ultraviolet curing resins in addition to the solid materials have been proposed. However, when applying a thermoset resin or ultraviolet curing resin to the solid electrolyte layer, there was a limitation in that each resin penetrated into the solid electrolyte layer, causing a side reaction, or penetrating into the contact surface with the positive electrode.

Accordingly, there is a need to develop an electrode protection member that can prevent internal short circuits and suppress side reactions in all-solid-state batteries.

### SUMMARY

The present invention is to solve the above-mentioned problem, and is to provide an electrode protection member that can prevent each resin from penetrating into a positive electrode, suppress side reactions within an all-solid-state battery, and firmly bind to the electrode and the solid electrolyte layer, by disposing a composite resin including a thermoset resin and an ultraviolet curing resin on a carbon-based tubular body whose surface is functionalized with a hydroxy group.

In one aspect, an electrode protection member is provided comprising: 1) a lower structure comprising a carbon-based body whose surface comprises or is functionalized with one or more hydroxy groups; and 2) a composite resin part comprising a thermoset resin and an ultraviolet curing resin disposed on the lower structure.

In aspects, the carbon-based body is a tubular body. The carbon-based based also may have other configurations.

An exemplary embodiment of the present invention provides an electrode protection member comprising a lower structure including a carbon-based tubular body whose surface is functionalized with a hydroxy group; and a composite resin part including a thermoset resin and an ultraviolet curing resin disposed on the lower structure.

The lower structure may be a porous plate-shaped structure in which a plurality of the carbon-based tubular bodies are connected to each other by point contact. The porous plate-shaped structure has a porosity of about 60 to about 95%. The lower structure may be a web-shaped plate-shaped structure in which the plurality of the carbon-based tubular bodies are irregularly connected. The lower structure may be a grid-shaped plate-shaped structure in which the plurality of the carbon-based tubular bodies are regularly connected.

The carbon-based tubular body may be solid or hollow. The carbon-based tubular body may include at least one or more selected from the group consisting of carbon fiber, carbon nanotube, graphene, and a mixture thereof. A surface of the carbon-based tubular body may be functionalized with or is treated to provide one or more hydroxy groups e.g. by treatment with a peroxide-based compound or other appropriate agent.

References herein to a carbon-based body (including a carbon-based tubular body) carbon-based may be comprised of at least or up to about 10, 20, 30, 40, 50, 60, 70, 80, 90, 95, 98, 99 or 100 weight percent carbon based on total weight of the carbon-based body. In certain aspects, a carbon-based body may be comprised at least or up to about 50, 60, 70, 80, 90, 95, 98, 99 or 100 weight percent carbon based on total weight of the carbon-based body. In yet additional aspects, a carbon-based body may be comprised at least or up to about 80, 90, 95, 98, 99 or 100 weight percent carbon based on total weight of the carbon-based body.

The thermoset resin may be a polyurethane-based polymer. The polyurethane-based polymer may contain OH functional groups and NCO functional groups at a molar ratio of about 1:1.4 to about 1:1.8.

The ultraviolet curing resin may include an acrylate-based polymer, a reactive diluent, and a photopolymerization initiator. The ultraviolet curing resin and the thermoset resin may be included in a weight ratio of about 1:0.4 to about 1:1.

In certain embodiments, an average thickness of the lower structure is about 10 to about 40 μm.

The carbon-based tubular body in the lower structure and the thermoset resin in the composite resin part may be connected to each other through a urethane bond.

In addition, another embodiment of the present invention provides an all-solid-state battery comprising a negative electrode; a solid electrolyte layer disposed on a surface of the negative electrode; a positive electrode disposed on a surface (e.g., in a center) of the solid electrolyte layer; and the electrode protection member disposed on the surface (e.g., the end side) of the solid electrolyte layer on which the positive electrode is not disposed.

An area on which the electrode protection member is disposed is about 5 to about 10% of an area of the negative electrode in contact with the solid electrolyte layer.

Still another embodiment of the present invention provides a method for manufacturing an all-solid state battery, comprising the steps of disposing and pressing a lower structure including a carbon-based tubular body whose surface is functionalized with a hydroxy group on a surface (e.g., the end side) of a solid electrolyte layer on which a positive electrode is not disposed in a laminate, wherein the laminate includes a negative electrode, the solid electrolyte layer disposed on a surface of the negative electrode, and the positive electrode disposed on a surface of (e.g., in a center) the solid electrolyte layer; disposing a mixture comprising a thermoset compound and an ultraviolet curing compound on the lower structure, and curing the thermoset compound; and curing the ultraviolet curing compound by irradiating the mixture with ultraviolet ray to form a composite resin part.

The pressing may be performed at a temperature of about 20 to about 30° C. and a pressure of about 2 to about 6 MPa.

The ultraviolet ray may be irradiated at a dose of about 1000 to about 1500 Mw/cm2 and at a speed of about 30 to about 40 mm/s.

The mixture for forming the composite resin part has a viscosity of about 10,000 to about 15,000 Cp.

By using the electrode protection member of the present invention and the all-solid-state battery containing the same, it is possible to prevent various resins used as the electrode protection member from penetrating into the electrode and the solid electrolyte layer, thereby suppressing side reactions due to the penetration. Further, by preventing steps due to differences in areas between the electrodes, an all-solid-state battery with a high stack structure can be implemented.

In addition, the thermoset resin included in the composite resin layer and the lower structure including the carbon-based tubular body functionalized with a hydroxy group forms a urethane bond, which is further final cured by the ultraviolet curing resin, so that the composite resin layer can be firmly bonded to the lower structure.

A term “all-solid-state battery” as used herein includes a rechargeable battery that includes an electrolyte in a solid state for transferring ions between the electrodes of the battery. In aspects, the battery can be a secondary battery.

In another aspect, a vehicle is provided that comprises a battery as disclosed herein.

### DESCRIPTION OF DRAWINGS

FIG. 1 is a diagram schematically illustrating a manufacturing process of an all-solid-state battery including an electrode protection material according to an exemplary embodiment of the present invention.

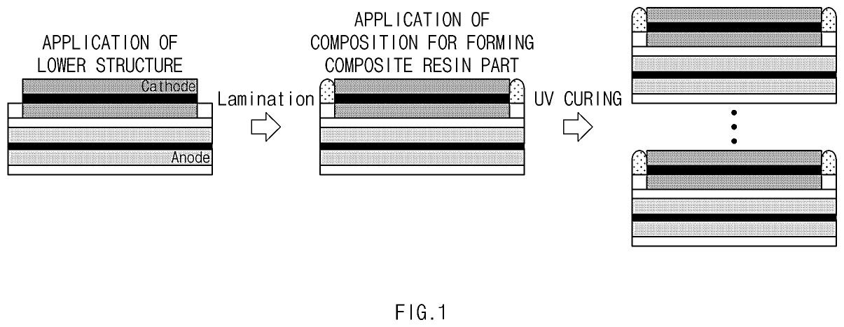

FIG. 2 is a diagram illustrating in detail a structure of an electrode protection material according to an exemplary embodiment of the present invention.

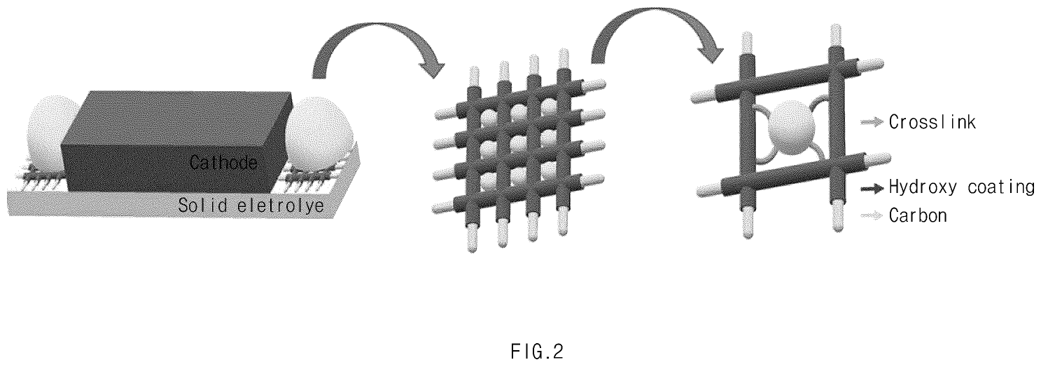

FIG. 3A is a diagram illustrating a degree of curing according to a weight ratio of thermoset resin and ultraviolet curing resin.

FIG. 3B is SEM and CT images of a solid electrolyte layer in contact with an electrode protection material in an all-solid-state battery according to Example 1.

FIG. 3C is SEM and CT images of a solid electrolyte layer in contact with an electrode protection material in an all-solid-state battery according to Comparative Example 1.

FIG. 4 is a diagram illustrating capacity retention rates of all-solid-state batteries according to Example 1 and Comparative Example 1 as a cycle progresses.

### DETAILED DESCRIPTION

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, an electrode protection member and an all-solid-state battery including the same will be described in detail so that those skilled in the art can easily practice the present invention.

An electrode protection member according to an exemplary embodiment of the present invention comprises a lower structure including a carbon-based tubular body whose surface is functionalized with a hydroxy group; and a composite resin part including a thermoset resin and an ultraviolet curing resin disposed on the lower structure.

The lower structure may be a porous plate-shaped structure in which a plurality of the carbon-based tubular bodies are connected to each other by point contact. Specifically, the lower structure may be a web-shaped plate-shaped structure in which the plurality of the carbon-based tubular bodies are irregularly connected. Alternatively, the lower structure may be a grid-shaped plate-shaped structure in which the plurality of the carbon-based tubular bodies are regularly connected. However, as long as the lower structure can provide a space for accommodating the composite resin part, the shape of the lower structure is not necessarily limited thereto.

The porous plate-shaped structure may have a porosity of about 60 to about 95%, preferably about 65 to about 90%, and more preferably about 70 to about 85%. Here, porosity refers to the ratio of the volume of total pores existing in the porous plate-shaped structure to the total volume of the porous plate-shaped structure. Meanwhile, the porosity of the porous plate-shaped structure may be measured using, for example, mercury intrusion porosimetry (MIP).

When the porosity of the porous plate-shaped structure satisfies the above numerical range, sufficient space is provided to accommodate the composite resin part, so that the combination of the lower structure and the composite resin part can be facilitated.

The average thickness of the lower structure may be about 10 to about 40 μm, preferably about 15 to about 35 μm, and more preferably about 20 to about 30 μm. When the average thickness of the plate-shaped structure satisfies the above numerical range, it can effectively prevent side reactions from occurring due to the composite resin part penetrating into the solid electrolyte layer disposed on a surface of the negative electrode, and protect the step formed due to the difference in area between the negative and positive electrodes.

The carbon-based body may be solid or hollow.

The carbon-based body may include at least one or more selected from the group consisting of carbon fiber, carbon nanotube, graphene, and a mixture thereof.

Specifically, the carbon nanotube may include at least one selected from the group consisting of a single-walled carbon nanotube, a double-walled carbon nanotube, a multi-walled carbon nanotube, and a bundled carbon nanotube.

The surface of the carbon-based body suitably may be functionalized with a hydroxy group by treatment with a peroxide-based compound.

The peroxide-based compound may include for example i) hydrogen peroxide; ii) at least one selected from the group consisting of peroxydiphosphoric acid (H₄P₂O₈), peroxydisulfuric acid (H₄S₂O₈), phthalimidoperoxycaproic acid, peroxyacetic acid (C₂H₄O₃), peroxybenzoic acid, diperoxyphthalic acid, and salts thereof, or iii) at least one selected from the group consisting of benzoyl peroxide, methyl ethyl ketone peroxide, dicumyl peroxide, and tert-butyl cumyl peroxide.

By functionalizing the surface of the carbon-based body with a hydroxy group, the carbon-based body may form a more robust bond with the composite resin included in the electrode protection member accommodated by the lower structure containing the carbon-based tubular body.

Specifically, the carbon-based body in the lower structure and the thermoset resin in the composite resin part may be connected to each other through a urethane bond. That is, the hydroxy group coated on the surface of the carbon-based body forms the urethane bond with the thermoset resin contained in the composite resin, so that the carbon-based body and the composite resin can be firmly connected.

The thermoset resin may be a polyurethane-based polymer. The polyurethane-based polymer refers to a polymer containing a urethane repeating unit formed by the reaction of isocyanate and polyol in a main chain. In this case, the isocyanate is a compound having 2 or more NCO groups, and the polyol is a compound having 3 or more hydroxyl groups.

The NCO group of the polyurethane-based polymer contained in the thermoset resin reacts with the hydroxy group on the surface of the carbon-based tubular body included in the lower structure to form the urethane bond, thereby allowing the lower structure and the composite resin part to be primarily bonded.

The isocyanate may include at least one or more selected from the group consisting of toluene diisocyanate (TDI), 4,4-diphenylmethane diisocyanate (MDI), 1,5-naphthalene diisocyanate (NDI), tolidine diisocyanate (TODI), hexamethylene diisocyanate (HMDI), isoprone diisocyanate (IPDI), p-phenylene diisocyanate, trans-cyclohexane, 1,4-diisocyanate, xylene diisocyanate (XDI), and a mixture thereof, but is not necessarily limited thereto.

Examples of the polyol may include, but may not be necessarily limited to, polyether-based polyol, polyester-based polyol, polycarbonate-based polyol, or polyalkylene-based polyol.

The polyether-based polyol may be obtained by adding alkylene oxide to a polyhydric alcohol having 3 or more hydroxyl groups, such as trimethylolpropane, glycerin, or pentaerythritol. The alkylene oxide may be, for example, ethylene oxide or propylene oxide.

The polyester-based polyol may be obtained by reacting low molecular weight diol, low molecular weight dicarboxylic acid, and triol.

The low molecular weight diol may include, for example, ethylene glycol, propylene glycol, 1,3-propanediol, 1,4-butadienediol, neopentyl glycol, 1,5-pentanediol, 1,6-hexanediol, diethylene glycol, cyclohexanediol, etc.

The low molecular weight dicarboxylic acid may include, for example, terephthalic acid, isophthalic acid, 1,5-naphthalic acid, 2,6-naphthalic acid, succinic acid, glutaric acid, adipic acid, pimelic acid, suberic acid, azelaic acid, sebacic acid, decamethylenedicarboxylic acid, dodecamethylenedicarboxylic acid, etc.

Examples of the triol may include trimethylolpropane, glycerin and the like.

Examples of the polycarbonate-based polyol may include polyhexamethylene carbonate polyol, polycyclohexanedimethylene carbonate polyol and the like.

Examples of the polyalkylene polyol may include polybutadiene polyol, hydrogenated polybutadiene polyol, hydrogenated polyisoprene polyol and the like.

The polyurethane-based polymer may contain OH functional groups and NCO functional groups at a molar ratio of about 1:1.4 to about 1:1.8, preferably about 1:4.5 to about 1:7.5, and more preferably about 1:1.5 to about 1:1.7. When the molar ratio of the OH functional group and the NCO functional group in the polyurethane polymer satisfies the above numerical range, a polyurethane-based compound with a three-dimensional structure having an NCO functional group at the terminal can be formed, which enables cross-linking with the hydroxy group present on the surface of the carbon-based tubular body included in the lower structure, thereby forming a strong urethane bond.

The ultraviolet curing resin may include an acrylate-based polymer, a reactive diluent, and a photopolymerization initiator. The ultraviolet curing resin may form a more robust electrode protection member by additionally combining the lower structure and the composite resin part through a curing reaction by ultraviolet irradiation.

The acrylate-based polymer may form a cured film, may affect the physical properties of the final ultraviolet curing resin, and may enable photocuring through an acrylate group, which is a reaction site for ultraviolet curing by ultraviolet rays.

The acrylate-based polymer may include at least one or more selected from the group consisting of epoxy acrylate, urethane acrylate, polyester acrylate, polyether acrylate, and silicone acrylate.

The reactive diluent may serve as a crosslinking agent for the acrylate-based polymer and may serve to adjust the viscosity of the ultraviolet curing resin to an appropriate range.

The reactive diluent may include a radical photocurable compound. Specifically, the reactive diluent may include a monofunctional acrylate-based monomer.

The monofunctional acrylate-based monomer may include at least one or more selected from the group consisting of methyl methacrylate (MMA), ethyl methacrylate, propyl(meth)acrylate, butyl(meth)acrylate, 2-ethylhexyl(meth)acrylate, lauryl(meth)acrylate, stearyl(meth)acrylate, methoxyethyl(meth)acrylate, ethoxyethyl(meth)acrylate, ethyl acrylate (HEA), glycidyl methacrylate (GMA), 2-hydroxy ethyl methacrylate (2-HEMA), acryloyl morpholine (ACMO), isobornyl acrylate (IBOA), 2-hydroxy propyl methacrylate (2-HPMA), hydroxy propyl acrylate (HPA), ethoxyethoxy ethyl acrylate (EOEOEA), butyl acrylate (BA), and a mixture thereof, but is not necessarily limited thereto.

The photopolymerization initiator may serve to initiate polymerization by absorbing ultraviolet rays and generating radicals or cations.

The photopolymerization initiator may include at least one or more selected from the group consisting of benzoin, benzoin methyl ether, benzoin ethyl ether, benzoin isopropyl ether, benzoin-n-butyl ether, benzoin isobutyl ether, acetophenone, dimethylamino acetophenone, 2,2-dimethoxy-2-phenylacetophenone, 2,2-diethoxy-2-phenylacetophenone, 2-hydroxy-2-methyl-1-phenylpropan-1-one, 1-hydroxycyclohexylphenylketone, 2-methyl-1-[4-(methylthio)phenyl]-2-morpholino-propan-1-one, 4-(2-hydroxyethoxy)phenyl-2(hydroxy-2-propyl)ketone, benzophenone, p-phenylbenzophenone, 4,4′-diethylaminobenzophenone, dichlorobenzophenone, 2-methylanthraquinone, 2-ethylanthraquinone, 2-tertiary-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyldimethylketal, acetophenone dimethylketal and p-dimethylaminobenzoic acid ester, but is not necessarily limited thereto.

The ultraviolet curing resin and the thermoset resin may be included in a weight ratio of about 1:0.4 to about 1:1, preferably about 1:0.4 to about 1:0.6. When the weight ratio of the thermoset resin and the ultraviolet curing resin satisfies the above numerical range, the curing rate of the composite resin is further improved and can be completely cured, thereby preventing the composite resin from being impregnated (or penetrated) into the solid electrolyte layer of the all-solid-state battery.

Another embodiment of the present invention provides an all-solid-state battery comprising a negative electrode; a solid electrolyte layer disposed on a surface of the negative electrode; a positive electrode disposed on a surface (e.g., in a center) of the solid electrolyte layer; and the electrode protection member disposed on the surface (e.g., the end side) of the solid electrolyte layer where the positive electrode is not disposed.

The negative electrode may be manufactured by coating a slurry containing a negative electrode active material, a binder, and a conductive material on a negative electrode current collector.

The negative electrode active material may include, for example, one or more selected from the group consisting of natural graphite, artificial graphite, carbonaceous materials; lithium-containing titanium composite oxide (LTO), Si, SiOₓ, Sn, Li, Zn, Mg, Cd, Cc, Ni, or Fe metals (Me); alloys composed of the above metals (Me) the above metals (Me) oxide (MeOₓ); and a composite of the above metals (Me) and carbon.

The binder may include, for example, one or more selected from the group consisting of polyvinylidene fluoride, polyvinyl alcohol, carboxymethylcellulose, starch, hydroxypropylcellulose, recycled cellulose, polyvinylpyrrolidone, tetrafluoroethylene, polyethylene, polypropylene, ethylene-propylene-diene monomer, sulfonated ethylene-propylene-diene monomer, styrene-butadiene rubber, fluorine rubber, and a copolymer thereof.

The conductive material may include graphite such as natural graphite or artificial graphite; carbon black such as acetylene black, Ketjen black, channel black, furnace black, lamp black, and thermal black; conductive fiber such as carbon fiber and metal fiber; metal powder such as carbon fluoride, aluminum, and nickel powder; conductive whisker such as zinc oxide and potassium titanate; conductive metal oxide such as titanium oxide; conductive material such as polyphenylene derivative, but is not necessarily limited thereto. Any material that has conductivity without causing chemical changes in the battery is applicable as the conductive material.

The negative electrode current collector may include, for example, copper, stainless steel, aluminum, nickel, titanium, calcined carbon, copper or stainless steel that is surface-treated with carbon, nickel, titanium, silver, or the like, aluminum-cadmium alloy, etc.

The type of solid electrolyte included in the solid electrolyte layer may include, for example, a sulfide-based solid electrolyte, an oxide-based solid electrolyte, or a polymer-based solid electrolyte, but is not particularly limited thereto.

The sulfide-based solid electrolyte may include a compound represented by the following Formula (1).

M¹ₐM²_{b}S_{c}X₁^{d} [Formula 1]

In Formula 1, M¹ is one or more selected from an alkali metal and an alkaline earth metal, and M² is Sb, Sn, Mg, Ba, B, Al, Ga, In, Si, Ge, Pb, N, P, As, Bi, Ti, V, Cr, Mn, Fe, Co, Ni, Cu, Y, Zr, Nb, Mo, Tc, Ru, Rh, Pd, Ag, Hf, Ta, W or La, X¹ is F, Cl, Br, I, O, Se or Te, 0<a≤6, 0<b≤6, 0<c≤6, and 0≤d≤6.

The oxide-based solid electrolyte may include at least one or more selected from the group consisting of an LLTO-based compound, Li₆La₂CaTa₂O₁₂, Li₆La₂ANb₂O₁₂ (A=Ca or Sr), Li₂Nd₃TeSbO₁₂, Li₃BO_{2.5}N_{0.5}, Li₉SiAlO₈, LAGP-based compound, LATP-based compound, Li₁₊ₐ₁Ti₂₋ₐ₁Alₐ₁Si_{b1}(PO₄)_{3-b1} (where 0≤a1≤1, 0≤b1≤1), LiAlₐ₂Zr₂₋ₐ₂(PO₄)₃ (where 0≤a2≤1), LiTiₐ₃Zr₂₋ₐ₃(PO₄)₃ (where 0≤a3≤1), LISICON-based compound, LIPON-based compound, perovskite-based compound, nasicon-based compound, and LLZO-based compound.

The polymer-based solid electrolyte may include, for example, one or more selected from the group consisting of polyether-based polymer, polycarbonate-based polymer, acrylate-based polymer, polysiloxane-based polymer, phosphazene-based polymer, polyethylene derivative, alkylene oxide derivative such as poly ethylene oxide (PEO), phosphoric acid ester polymer, polyagitation lysine, polyester sulfide, polyvinyl alcohol, polyvinylidene fluoride, and polymer containing an ionically dissociable group, but is not necessarily limited thereto.

The positive electrode may be manufactured by coating a slurry containing a positive electrode active material, a binder, and a conductive material on a positive electrode current collector.

The positive electrode active material may include, for example, lithium-manganese-based oxide such as LiMnO₂, LiMn₂O₄, lithium-cobalt-based oxide such as LiCoO₂, lithium-nickel-based oxide such as LiNiO₂, lithium-nickel-manganese-cobalt-based oxide such as Li(Ni_{1/3}Mn_{1/3}Co_{1/3})O₂, Li(Ni_{0.6}Mn_{0.2}Co_{0.2})O₂, Li(Ni_{0.5}Mn_{0.3}Co_{0.2})O₂, Li(Ni_{0.7}Mn_{0.15}Co_{0.15})O₂ and Li(Ni_{0.8}Mn_{0.1}Co_{0.1})O₂, or lithium-nickel-cobalt-aluminum oxide such as Li(Ni_{0.8}Co_{0.15}Al_{0.05})O₂, but is not necessarily limited thereto.

The binder and the conductive material may be the same as those described for the negative electrode.

The positive electrode current collector may include, for example, stainless steel, aluminum, nickel, titanium, calcined carbon, aluminum or stainless steel that is surface-treated with carbon, nickel, titanium, silver, or the like, etc.

The area where the electrode protection member is disposed may be about 5 to about 10%, preferably about 5.5 to about 9.5%, and more preferably about 6 to about 9% of the area of the negative electrode in contact with the solid electrolyte layer.

The solid electrolyte layer having the same area as the negative electrode is disposed on a surface of the negative electrode, and the positive electrode is disposed on the solid electrolyte layer, specifically in the center of the solid electrolyte layer. In particular, the areas of the negative electrode and solid electrolyte layer are larger than the area of the positive electrode. Thus, due to this difference in area, the remaining area of the solid electrolyte layer, excluding the positive electrode disposed on a surface (e.g., in a center) of the solid electrolyte layer, may be exposed to the outside. The all-solid-state battery according to the present invention has a structure in which the electrode protection member is disposed on the surface (e.g., the end side) of the solid electrolyte layer where the positive electrode is not disposed. Through this, the area difference caused by the area of the positive electrode being smaller than the area of the solid electrolyte layer can be eliminated, and the portion of the area of the solid electrolyte layer exposed to the outside can be covered with the electrode protection member.

By disposing the electrode protection member according to the present invention on the surface (e.g., the end side) of the solid electrolyte layer where the positive electrode is not disposed, the occurrence of cracks can be prevented under pressurized conditions during the manufacture of an all-solid-state battery. In addition, when a conventional thermoset resin or ultraviolet curing resin is applied, the resin penetrates into the solid electrolyte layer, causing a side reaction, or penetrates into the positive electrode, forming a step due to the difference in area between the electrodes, resulting in the formation of an unstable electrode when forming a laminated structure. On the contrary, in the present invention, by applying the electrode protection member, side reactions can be suppressed and an all-solid-state battery with a high stack structure can be formed.

Still another embodiment of the present invention provides a method for manufacturing an all-solid-state battery, comprising the steps of disposing and pressing a lower structure including a carbon-based tubular body whose surface is functionalized with a hydroxy group on a surface (e.g., the end side) of a solid electrolyte layer where a positive electrode is not disposed in a laminate, wherein the laminate includes a negative electrode, the solid electrolyte layer disposed on a surface of the negative electrode, and the positive electrode disposed on a surface (e.g., in a center) of the solid electrolyte layer; disposing a mixture for forming a composite resin part including a thermoset compound (i.e., a compound that is cured by heat) and an ultraviolet curing compound (i.e., a compound that is cured by ultraviolet rays) on the lower structure, and curing the thermoset compound; and curing the ultraviolet curing compound by irradiating the pressurized mixture for forming the composite resin part with ultraviolet ray.

First, the step of disposing and pressing the lower structure including the carbon-based tubular body functionalized with a hydroxy group on a surface (e.g., the end side) of the solid electrolyte layer where the positive electrode in the laminate is performed. The laminate includes the negative electrode, the solid electrolyte layer disposed on a surface of the negative electrode, and the positive electrode disposed on a surface (e.g., in a center) of the solid electrolyte layer.

Here, regarding the negative electrode, positive electrode, solid electrolyte layer, and lower structure, the descriptions for the electrode protection member and the all-solid-state battery can be applied equally.

The pressurization may be performed at a temperature of about 20 to about 30° C. and a pressure of about 2 to about 6 MPa, preferably about 2.5 to about 5.5 MPa, and more preferably about 3 to about 5 MPa. When pressurization is performed under the above pressure conditions, the porosity of the lower structure reaches about 60 to about 95%, preferably about 65 to about 90%, and more preferably about 70 to about 85%, thereby providing sufficient space to accommodate the composite resin part. The average thickness of the lower structure is about 10 to about 40 μm, preferably about 15 to about 35 μm, more preferably about 20 to about 30 μm, so that it can effectively suppress the occurrence of side reactions due to penetration of the composite resin part into the solid electrolyte layer disposed on a surface of the negative electrode, and protect the step formed due to the difference in areas between the negative and positive electrodes.

Meanwhile, the pressurization may be performed for about 4 to about 11 seconds, preferably about 5 to about 10 seconds.

Next, the step of disposing the mixture for forming the composite resin part including the thermoset compound and the ultraviolet curing compound on the lower structure, and curing the thermoset compound is performed.

The thermoset compound may include a polyurethane-based polymer. The polyurethane-based polymer may contain OH functional groups and NCO functional groups at a molar ratio of about 1:1.4 to about 1:1.8, preferably about 1:4.5 to about 1:7.5, and more preferably about 1:1.5 to about 1:1.7. When the molar ratio of the OH functional group and the NCO functional group in the polyurethane-based polymer satisfies the above numerical range, a polyurethane-based compound with a three-dimensional structure having an NCO functional group at the terminal can be formed, which enables cross-linking with the hydroxy group present on the surface of the carbon-based tubular body included in the lower structure, thereby forming a strong urethane bond.

When the mixture for forming the composite resin part is applied on the lower structure, the NCO group of the thermoset compound in the mixture for forming the composite resin part and the hydroxyl group on the surface of the carbon-based tubular body included in the lower structure in contact with the mixture for forming the composite resin part may react first to form the urethane bond. In this case, the mixture for forming the composite resin part may be in a semi-cured state that is not completely cured.

Lastly, the step of curing the ultraviolet curing compound by irradiating ultraviolet ray to the pressurized mixture for forming the composite resin part is performed.

The ultraviolet curing compound may include an acrylate-based polymer, a reactive diluent, and a photopolymerization initiator. The ultraviolet curing compound may form a more robust electrode protection member by additionally combining the lower structure and the composition for forming the composite resin part through the curing reaction by ultraviolet irradiation. In this case, the composition for forming the composite resin part may be in a completely cured state.

The acrylate-based polymer forms a cured film, can affect the physical properties of the final ultraviolet curing resin, and can enable photocuring through an acrylate group, which is a reaction site for ultraviolet curing by ultraviolet rays.

The acrylate-based polymer may include at least one or more selected from the group consisting of epoxy acrylate, urethane acrylate, polyester acrylate, polyether acrylate, and silicone acrylate.

The reactive diluent serves as a crosslinking agent for the acrylate-based polymer and may serve to adjust the viscosity of the ultraviolet curing resin to an appropriate range.

The reactive diluent may include a radical photocurable compound. Specifically, the reactive diluent may include a monofunctional acrylate-based monomer.

The monofunctional acrylate-based monomer may include at least one or more selected from the group consisting of methyl methacrylate (MMA), ethyl methacrylate, propyl(meth)acrylate, butyl(meth)acrylate, 2-ethylhexyl(meth)acrylate, lauryl(meth)acrylate, stearyl(meth)acrylate, methoxyethyl(meth)acrylate, ethoxyethyl(meth)acrylate, ethyl acrylate (HEA), glycidyl methacrylate (GMA), 2-hydroxy ethyl methacrylate (2-HEMA), acryloyl morpholine (ACMO), isobornyl acrylate (IBOA), 2-hydroxy propyl methacrylate (2-HPMA), hydroxy propyl acrylate (HPA), ethoxyethoxy ethyl acrylate (EOEOEA), butyl acrylate (BA), and a mixture thereof, but is not necessarily limited thereto.

The photopolymerization initiator may serve to initiate polymerization by absorbing ultraviolet rays and generating radicals or cations.

The photopolymerization initiator may include at least one or more selected from the group consisting of benzoin, benzoin methyl ether, benzoin ethyl ether, benzoin isopropyl ether, benzoin-n-butyl ether, benzoin isobutyl ether, acetophenone, dimethylamino acetophenone, 2,2-dimethoxy-2-phenylacetophenone, 2,2-diethoxy-2-phenylacetophenone, 2-hydroxy-2-methyl-1-phenylpropan-1-one, 1-hydroxycyclohexylphenylketone, 2-methyl-1-[4-(methylthio)phenyl]-2-morpholino-propan-1-one, 4-(2-hydroxyethoxy)phenyl-2(hydroxy-2-propyl)ketone, benzophenone, p-phenylbenzophenone, 4,4′-diethylaminobenzophenone, dichlorobenzophenone, 2-methylanthraquinone, 2-ethylanthraquinone, 2-tertiary-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyldimethylketal, acetophenone dimethylketal and p-dimethylaminobenzoic acid ester, but is not necessarily limited thereto.

The ultraviolet ray may be irradiated at a dose of about 1000 to about 1500 Mw/cm² and at a speed of about 30 to about 40 mm/s, preferably at a dose of about 1050 to about 1450 Mw/cm² and at a speed of about 32 to about 38 mm/s, more preferably at a dose of about 1100 to about 1400 Mw/cm² and a speed of about 33 to about 37 mm/s. When the irradiation of ultraviolet ray is carried out under the above conditions, the mixture for forming the composite resin part is completely cured to form a robust electrode protection material on the solid electrolyte layer where the positive electrode is not disposed, and the step due to the difference in areas between the negative and positive electrodes can be effectively removed.

Meanwhile, the irradiation of ultraviolet ray may be performed for about 20 to about 30 seconds, preferably about 22 to about 27 seconds.

The mixture for forming the composite resin part may have a viscosity of about 10,000 to about 15,000 Cp, preferably about 10,500 to about 14,500 Cp, and more preferably about 11,000 to about 14,000 Cp. When the mixture for forming the composite resin part has the above viscosity, the formed lower structure and the composite resin part can be completely cured, and thus the electrode protection function of the electrode protection member can be improved.

In addition, the mixture for forming the composite resin part may contain a solid content of about 10 to about 15%, preferably about 10.5 to about 14.5%, and more preferably about 11 to about 14%, based on the total weight of the mixture. When the mixture for forming the composite resin part has the solid content, the formed lower structure and the composite resin part can be completely cured, and thus the electrode protection function of the electrode protection member can be improved.

Hereinafter, the present invention will be described in more detail through Examples. However, these Examples are only intended to aid understanding of the present invention, and the scope of the present invention is not limited to these Examples in any way.

### <Example 1> Manufacturing 1 of an all-Solid-State Battery Including an Electrode Protection Material

An all-solid-state battery was manufactured such that a positive electrode current collector, a positive electrode layer, a solid electrolyte layer, a negative electrode layer, and a negative electrode current collector were stacked in that order. An aluminum (Al) was used as the positive electrode current collector, the positive electrode layer including a positive electrode active material, a conductive material, and a binder was prepared, and oxide was used as the positive electrode active material.

In addition, a sulfide-based solid electrolyte with high lithium ion conductivity was applied to the solid electrolyte layer. The negative electrode layer located on one surface of the solid electrolyte layer was formed by coating a carbonaceous material, which is a negative electrode active material, on a metal thin film containing nickel, which is a negative electrode current collector.

In this case, the area of the positive electrode layer was formed to be about 90 to 95% of the area of the solid electrolyte layer.

Next, carbon nanotubes and hydrogen peroxide were reacted to prepare the lower structure coated with hydroxy groups, and the lower structure was disposed on the area difference between the solid electrolyte membrane and the negative electrode, that is, on the solid electrolyte membrane where the negative electrode was not disposed. Afterwards, it was rolled for 7 seconds at 25° C. at a pressure of 4 MPa.

A mixture slurry for forming the composite resin part including an acrylate-based polymer as the ultraviolet curing compound and a polyurethane-based polymer as the thermoset compound at a weight ratio of 1:0.4 was applied on the lower structure.

Next, ultraviolet rays were irradiated at an illumination intensity of 1200 mW/cm² and a speed of 35 mm/s for 25 seconds to completely cure the composite resin composition slurry.

### <Example 2> Manufacturing 2 of an all-Solid-State Battery Including an Electrode Protection Material

An electrode protection material and an all-solid-state battery were manufactured in the same manner as in Example 1, except that the weight ratio of the ultraviolet curing compound and the thermoset compound was 1:0.6.

### <Example 3> Manufacturing 3 of an all-Solid-State Battery Including an Electrode Protection Material

An electrode protection material and an all-solid-state battery were manufactured in the same manner as in Example 1, except that the weight ratio of the ultraviolet curing compound and the thermoset compound was 1:1.

### <Comparative Example 1> Manufacturing 4 of an all-Solid-State Battery Including an Electrode Protection Material

An electrode protection material and an all-solid-state battery were manufactured in the same manner as Example 1, except that only the thermoset compound was applied without the ultraviolet curing compound.

### <Comparative Example 2> Manufacturing 5 of an all-Solid-State Battery Including an Electrode Protection Material

An electrode protection material and an all-solid-state battery were manufactured in the same manner as Example 1, except that only the ultraviolet curing compound was applied without the thermoset compound.

### <Reference Example 1> Manufacturing 6 of an all-Solid-State Battery Including an Electrode Protection Material

An electrode protection material and an all-solid-state battery were manufactured in the same manner as in Example 1, except that the weight ratio of the ultraviolet curing compound and the thermoset compound was 1:2.5.

### <Reference Example 2> Manufacturing 7 of an all-Solid-State Battery Including an Electrode Protection Material

An electrode protection material and an all-solid-state battery were manufactured in the same manner as in Example 1, except that the weight ratio of the ultraviolet curing compound and the thermoset compound was 1:1.67.

### <Comparative Example 3> Manufacturing of an all-Solid-State Battery Including No Electrode Protection Material

An all-solid-state battery was manufactured in the same manner as Example 1, except that the composite resin composition slurry was not applied and cured on the lower structure.

### <Experimental Example 1> Evaluation of a Degree of Curing and Penetration into a Solid Electrolyte Layer According to a Weight Ratio of Ultraviolet Curing Resin and Thermoset Resin

The electrode protection materials of the all-solid-state batteries according to Example 1, Example 2, Comparative Example 1, Comparative Example 2, Reference Example 1, and Reference Example 2 were immersed in tetrahydrofuran (THF), a solvent. Afterwards, the gel fraction of the composite resin composition and whether the resin penetrated into the solid electrolyte layer were observed according to the weight ratio of the ultraviolet curing resin and the thermoset resin contained in the composite resin part, and were shown in Table 1 below.

Here, the gel fraction is a value calculated through Equation 1 below, Wo is the weight (g) of the sample before immersion, and W₂₄ is the weight (g) of the sample after immersion for 24 hours.

$$Gel fraction ( \% ) = \frac{{W}_{24}}{{W}_{0}} \times 100 \qquad [ Equation 1 ]$$

In addition, the penetration of the resin of the composite resin part into the solid electrolyte layer was evaluated with the naked eye, and the penetration resistance was evaluated using the following grades.
⊚: No penetration of resin was confirmed at all.
∘: Penetration of resin was hardly confirmed.
Δ: Penetration of resin was faintly confirmed.
X: Significant penetration of resin was confirmed

TABLE 1

| | Weight ratio of | | Penetration |
|---|---|---|---|
| | ultraviolet curing resin | Gel | into a solid |
| | and thermoset resin | fraction(%) | electrolyte layer |
| Example 1 | 1:0.4 | 100 | ⊚ |
| Example 2 | 1:0.6 | 100 | ⊚ |
| Example 3 | 1:1 | 82 | ◯ |
| Comparative | 0:1 | 28 | X |
| Example 1 | | | |
| Comparative | 1:0 | 72 | Δ |
| Example 2 | | | |
| Reference | 1:2.5 | 52 | X |
| Example 1 | | | |
| Reference | 1:1.67 | 74 | Δ |
| Example 2 | | | |

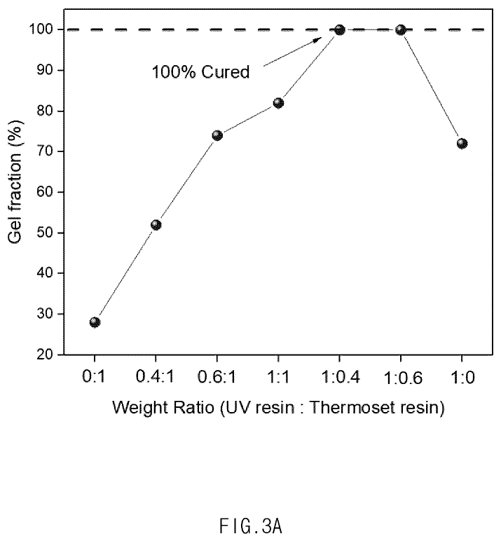

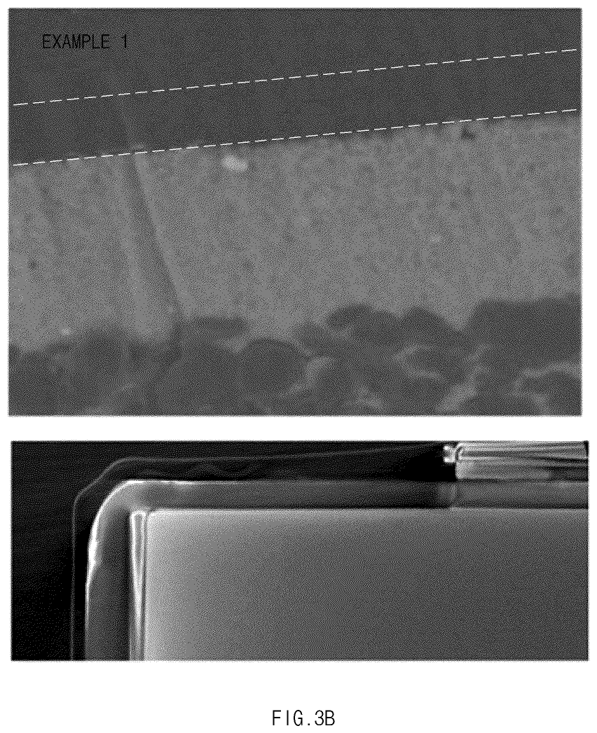

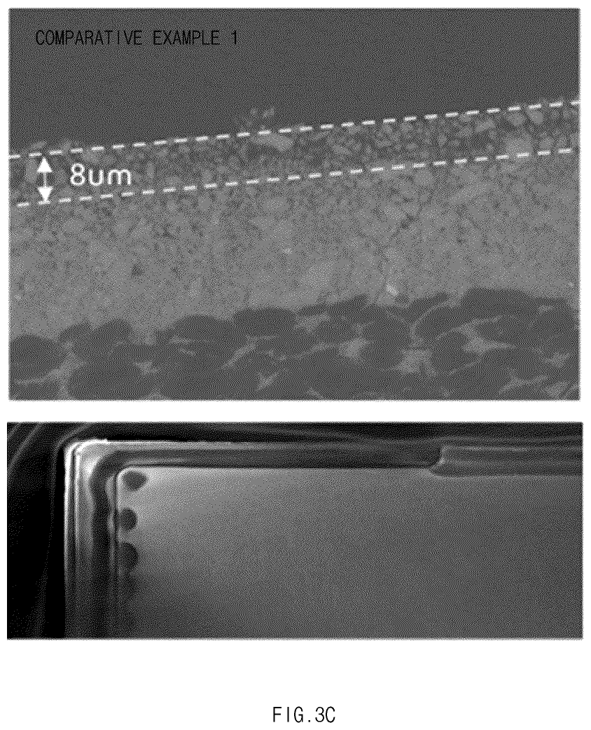

Referring to FIG. 3A and Table 1, in the case of Examples 1 to 3 in which the weight ratio of the ultraviolet curing resin and thermoset resin of the composite resin part satisfied the range of 1:0.4 to 1:1, the gel fraction was 80% or more and little or no resin penetrated into the composite resin part. In particular, in the case of Examples 1 and 2 that satisfied the range of 1:0.4 to 1:0.6, the gel fraction was 100% and the resin of the composite resin part did not penetrate into the solid electrolyte layer at all. On the contrary, in the case of Comparative Example 1, Comparative Example 2, Reference Example 1, and Reference Example 2 in which the weight ratios were outside the above numerical range, only portion of the composition was converted to a gel form, and some portions of the composition penetrated into the solid electrolyte layer.

In addition, FIGS. 3B and 3C illustrated SEM and CT imaging results of the portions of the electrode protection member of the all-solid-state batteries according to Example 1 and Comparative Example 1, respectively. In Example 1, it was confirmed that the composition of the composite resin part did not penetrate into the solid electrolyte, whereas in Comparative Example 1, it was confirmed that penetration into the solid electrolyte occurred.

### <Experimental Example 2> Performance Evaluation of an all-Solid-State Battery Including an Electrode Protection Material

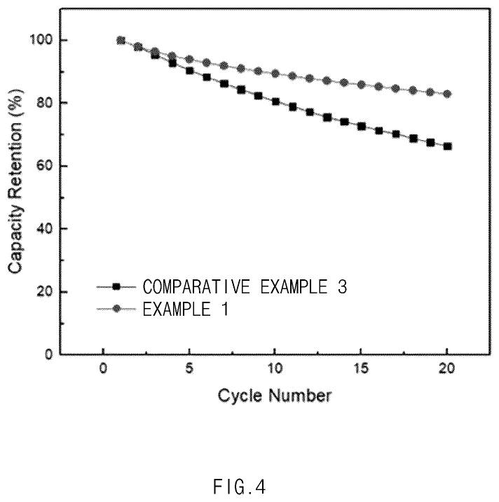

The capacity retention rates according to cycle progress were measured for the all-solid-state batteries including the electrode protection materials according to Example 1 and Comparative Example 3, and were shown in FIG. 4. Here, the discharge was conducted under conditions of 200 mA/cm² to 300 mA/cm².

As the cycle progressed, it was confirmed that Example 1 had superior capacity retention rate compared to Comparative Example 3. This is because the electrode protection material is firmly positioned in the step formed due to the size difference between the positive and negative electrodes, thereby effectively suppressing penetration of the composition within the composite resin part into the solid electrolyte.

1. An electrode protection member comprising:
a lower structure comprising a carbon-based body whose surface comprises or is functionalized with one or more hydroxy groups; and
a composite resin part comprising a thermoset resin and an ultraviolet curing resin disposed on the lower structure.

2. The electrode protection member of claim 1 wherein the carbon-based body is a carbon-based tubular body.

3. The electrode protection member of claim 1, wherein the lower structure is a porous plate-shaped structure in which a plurality of the carbon-based bodies are connected to each other by point contact.

4. The electrode protection member of claim 2, wherein the lower structure is a web-shaped plate-shaped structure in which the plurality of the carbon-based bodies are irregularly connected.

5. The electrode protection member of claim 2, wherein the lower structure is a grid-shaped plate-shaped structure in which the plurality of the carbon-based bodies are regularly connected.

6. The electrode protection member of claim 1, wherein the carbon-based body is solid or hollow.

7. The electrode protection member of claim 1, wherein the carbon-based body comprises at least one or more selected from the group consisting of carbon fiber, carbon nanotube, graphene, and a mixture thereof.

8. The electrode protection member of claim 1, wherein a surface of the carbon-based body is functionalized with a hydroxy group by treatment with a peroxide-based compound.

9. The electrode protection member of claim 1, wherein the thermoset resin is a polyurethane-based polymer.

10. The electrode protection member of claim 8, wherein the polyurethane-based polymer contains OH functional groups and NCO functional groups at a molar ratio of about 1:1.4 to about 1:1.8.

11. The electrode protection member of claim 1, wherein the ultraviolet curing resin comprises an acrylate-based polymer, a reactive diluent, and a photopolymerization initiator.

12. The electrode protection member of claim 1, wherein the ultraviolet curing resin and the thermoset resin is included in a weight ratio of about 1:0.4 to about 1:1.

13. The electrode protection member of claim 2, wherein the porous plate-shaped structure has a porosity of about 60 to about 95%.

14. The electrode protection member of claim 1, wherein an average thickness of the lower structure is about 10 to about 40 m.

15. The electrode protection member of claim 1, wherein the carbon-based tubular body in the lower structure and the thermoset resin in the composite resin part are connected to each other through a urethane bond.

16. An all-solid-state battery comprising:
a negative electrode;
a solid electrolyte layer disposed on a surface of the negative electrode;
a positive electrode disposed on a surface of the solid electrolyte layer; and
the electrode protection member of claim 1 that is disposed on the surface of the solid electrolyte layer on which the positive electrode is not disposed.

17. The all-solid-state battery of claim 16, wherein an area on which the electrode protection member is disposed is about 5 to about 10% of an area of the negative electrode in contact with the solid electrolyte layer.

18. A method for manufacturing an all-solid-state battery, the method comprising steps of:
disposing and pressing a lower structure comprising a carbon-based body whose surface is functionalized with or comprises a hydroxy group on a surface of a solid electrolyte layer on which a positive electrode is not disposed in a laminate, wherein the laminate comprises a negative electrode, the solid electrolyte layer disposed on a surface of the negative electrode, and the positive electrode disposed on a surface of the solid electrolyte layer;
disposing a mixture comprising a thermoset compound and an ultraviolet curing compound on the lower structure, and curing the thermoset compound; and
curing the ultraviolet curing compound by irradiating the mixture with ultraviolet ray to form a composite resin part.

19. The method of claim 18, wherein the pressing is performed at a temperature of about 20 to about 30° C. and a pressure of about 2 to about 6 MPa.

20. The method of claim 18, wherein the ultraviolet ray is irradiated at a dose of about 1000 to about 1500 mW/cm² and at a speed of about 30 to about 40 mm/s, and the mixture for forming the composite resin part has a viscosity of about 10,000 to about 15,000 Cp.
